(19) United States
(12) Patent Application Publication
(10) Pub. No.: US 2006/0119551 A1
(43) Pub. Date: Jun. 8, 2006

(54) Automatic adaptation of the supply voltage of an electroluminescent display according to the desired luminance

(75) Inventors: Danika Chaussy, Brie Et Angonne (FR); Celine Mas, Poisat (FR)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: STMicroelectronics S.A., Montrouge (FR)

(21) Appl. No.: 11/294,945

(22) Filed: Dec. 6, 2005

(30) Foreign Application Priority Data
Dec. 6, 2004 (FR) FR04/52868

(51) Int. Cl. G09G 3/30

(52) U.S. Cl. 345/76

(57) ABSTRACT

A device for regulating the bias voltage of circuits for controlling columns of a matrix display capable of selecting columns to turn on the light-emitting diodes of the selected columns and of a selected line, the device including a first measurement circuit providing a first measurement signal representative of the highest voltage among the voltages of the selected columns; a second measurement circuit providing a second measurement signal representative of the lowest voltage among the voltages of the selected columns; and an adjustment circuit receiving the first and second measurement signals and capable of decreasing the bias voltage if the first measurement signal is smaller than a first comparison signal and of increasing the bias voltage if the second measurement signal is greater than a second comparison signal.

### BACKGROUND OF THE INVENTION

1. Field of the Invention

The present invention relates to electroluminescent display matrix screens formed of a set of light-emitting diodes. Such screens are for example formed of organic diodes (“OLED”, for Organic Light Emitting Display) or polymer diodes (“PLED” for Polymer Light Emitting Display). The present invention more specifically relates to the regulation of the supply voltage of the control circuits of the light-emitting diodes of such screens.

2. Discussion of the Related Art

FIG. 1 shows a matrix screen comprised of n columns C₁ to Cₙ and k lines L₁ to Lₖ enabling addressing n*k light-emitting diodes d having their anodes connected to a column and their cathodes connected to a line.

Line control circuits CL₁ to CLₖ enable respectively biasing lines L₁ to Lₖ. A single line is activated at a time and is biased to ground. The non-activated lines are biased to a voltage V_{ligne}.

Column control circuits CC₁ to CCₙ enable respectively biasing columns C₁ to Cₙ. The columns addressing the light-emitting diodes which are desired to be activated are biased by a current to a voltage V_{COL} greater than the threshold voltage of the screen light-emitting diodes. The columns which are not desired to be activated are grounded.

A light-emitting diode connected to the activated line and to a column biased to V_{COL} is then on and emits light. Voltage V_{ligne} is provided to be high enough for the light-emitting diodes connected to the non-activated lines and to the columns at voltage V_{COL} not to be on and to emit no light.

FIG. 2 shows a conventional example of a column control circuit CC and of a line control circuit CL respectively addressing a column C and a line L connected to a light-emitting diode d of the screen. Line control circuit CL comprises a power inverter 1 controlled by a line control signal φ_{L}. Power inverter 1 comprises an NMOS transistor 2 enabling discharging line L when φ_{L} is high and a PMOS transistor 3 enabling charging line L to bias voltage V_{ligne} when φ_{L} is low.

Column control circuit CC comprises a current mirror formed in the present example with two PMOS-type transistors 4, 5. Transistor 4 forms the reference branch of the mirror and transistor 5 forms the duplication terminal. The sources of transistors 4 and 5 are connected to a bias voltage V_{POL} on the order of 15 V for OLED screens. The gates of transistors 4 and 5 are interconnected. The drain and the gate of transistor 4 are interconnected. Transistor 4 is thus diode-connected, the source-gate voltage (Vsg₄) being equal to the source-drain voltage (Vsd₄). The drain of transistor 4 is connected to the source of a PMOS-type power transistor 6. The drain and the gate of transistor 6 are interconnected. The drain of transistor 6 is connected to a terminal of a current source 7 having its other terminal connected to ground GND. The current flowing through transistor 4 is set by current source 7 which provides a so-called “luminance” current I_{LUM}.

The drain of transistor 5 is connected to the source of a PMOS-type power transistor 8. The drain of transistor 8 is connected to column C. A switch 9, controlled by a control signal φ_{C}, is capable of connecting the gate of transistor 8 to bias voltage V_{POL}, for example, when control signal φ_{C} is high, and to the gate of transistor 6 when control signal φ_{C} is low. When signal φ_{C} is low, transistor 8 is on and column C charges to reach voltage V_{COL}. When line L and column C are activated, line and column control signals φ_{L} and φ_{C} are respectively high and low, light-emitting diode d is on, and the current flowing through the diode is equal to luminance current I_{LUM}. The circuit for grounding column C when control signal φ_{C} is high is not shown.

For column control circuit CC to operate as described previously, it is necessary for voltage V_{POL} to be sufficiently high for the copying of voltage I_{LUM} to be correct. Bias voltage V_{POL} is equal to the sum of drain-source voltage Vds₂ of transistor 2, of voltage V_{d} across light-emitting diode d, of source-drain voltage Vsd₈ of transistor 8, and of source-drain voltage Vsd₅ of transistor 5.

When the copying of current I_{LUM} is correct, transistor 5 is in saturation state and voltage Vsd₅ is at least equal to source-drain voltage Vsd₄ of transistor 4. A correct copying of the current in the duplication branch thus causes bias voltage V_{POL} to be at least equal to the previously-mentioned sum when the current that it conducts is equal to luminance current I_{LUM}. If bias voltage V_{POL} is too low, the current flowing through light-emitting diode d is smaller than current I_{LUM} and the diode luminance is insufficient.

Luminance current I_{LUM} provided by current source 7 may generally vary according to the luminance desired for the screen. When luminance current I_{LUM} increases, source-drain voltage Vsd₄ of diode-assembled transistor 4 increases and voltage V_{d} of light-emitting diode d also increases. As a result, bias voltage V_{POL} must be high enough for transistor 5 to be in saturation whatever the luminance current.

However, for electric power saving reasons, bias voltage V_{POL} is desired to be decreased, which then enables reducing voltage V_{ligne} of the line control circuits.

There exist control circuits which have a fixed bias voltage V_{POL} determined according to the maximum desired luminance current I_{LUM}. The disadvantage of such circuits is their high electric power consumption.

There exist other control circuits for which bias voltage V_{POL} varies according to the desired luminance current I_{LUM}. If current I_{LUM} is low, voltage V_{POL} is low, and conversely. However, it is necessary to provide a security margin to take into account the aging of the screen light-emitting diodes. Indeed, for an equal current in light-emitting diode d, voltage V_{d} across the diode increases along time. For the same luminance, corresponding to a given luminance current, the necessary minimum bias voltage V_{POL} thus progressively increases with time. The obtained power savings for these circuits are thus not optimal.

### SUMMARY OF THE INVENTION

An object of the present invention is to provide a device for regulating the bias voltage of column control circuits providing the lowest bias voltage V_{POL} whatever the aging of the light-emitting diodes of the screen.

Another object of the present invention is to provide a device for regulating the bias voltage of control circuits of simple design.

To achieve these and other objects, the present invention provides a device for regulating the bias voltage of circuits for controlling columns of a matrix display formed of light-emitting diodes distributed in lines and in columns, the column control circuits being capable of selecting columns to turn on the light-emitting diodes of the selected columns and of a selected line of the matrix display, the device comprising a first measurement circuit providing a first measurement signal representative of the highest voltage among the voltages of the selected columns; a second measurement circuit providing a second measurement signal representative of the lowest voltage among the voltages of the selected columns; and an adjustment circuit receiving the first and second measurement signals and capable of decreasing the bias voltage if the first measurement signal is smaller than a first comparison signal and of increasing the bias voltage if the second measurement signal is greater than a second comparison signal.

According to an embodiment of the present invention, the adjustment circuit comprises a first storage circuit, capable of storing the first measurement signal for at least the duration of the display of an image on the matrix display in the absence of a new measurement of the first measurement signal; and a second storage circuit, capable of storing the second measurement signal for at least the duration of the display of an image on the matrix display in the absence of a new measurement of the second measurement signal.

According to an embodiment of the present invention, the first measurement circuit is capable of measuring the maximum voltage from among the voltages of the matrix display columns, the measurement circuit comprising a protection circuit capable of deactivating the measurement circuit for each column associated with a non-conductive light-emitting diode.

According to an embodiment of the present invention, the column control circuits are made in the form of a current mirror comprising a reference branch and several duplication branches connected to the bias voltage, each duplication branch being connected to a column, the reference branch comprising a field-effect PMOS-type reference transistor having its source connected to the bias voltage, and having its drain connected to a reference current source providing a current equal to a luminance current, the gate and the drain of the reference transistor being interconnected. Further, each duplication branch of the current mirror comprises a PMOS-type field-effect duplication transistor having its source connected to the bias voltage and having its drain connected to said column, the gates of the transistors of each branch being interconnected.

According to an embodiment of the present invention, the first measurement circuit comprises, for each column, a PMOS-type field-effect protection transistor having its source connected to the bias voltage and having its gate connected to the drain of the duplication transistor of the duplication branch associated with said column and an NMOS-type field effect measurement transistor, having its drain connected to the drain of the protection transistor and having its gate connected to the column, the sources of the first measurement transistors being connected to a measurement point.

According to an embodiment of the present invention, the reference branch further comprises a PMOS-type field-effect reference power transistor having its source connected to the drain of the reference transistor, the gate and the drain of the reference power transistor being connected to the reference current source. Each duplication branch further comprises a PMOS-type field-effect duplication power transistor having its source connected to the drain of the duplication transistor and having its drain connected to the column, and the gate of which is capable of being connected to the drain of the reference power transistor for selecting said column, the first comparison signal being the voltage at the drain of the reference power transistor.

According to an embodiment of the present invention, the second measurement circuit comprises, for each column, a PMOS-type field-effect measurement transistor having its drain connected to a reference voltage and having its gate connected to the column, the sources of the second measurement transistors being connected to a measurement point.

According to an embodiment of the present invention, the second comparison signal is equal to the bias voltage decreased by a determined constant voltage.

The present invention also provides a matrix display comprising light-emitting diodes distributed in lines and columns and column control circuits capable of selecting columns to turn on the light-emitting diodes of the selected columns and of a selected line, said matrix display further comprising a device for regulating the bias voltage of the column control circuits such as described hereabove.

The present invention also provides a method for regulating the bias voltage of circuits for controlling columns of a matrix display formed of light-emitting diodes distributed in lines and in columns, the column control circuits being capable of selecting columns to turn on the light-emitting diodes of the selected columns and of a selected line of the matrix display. The method comprises decreasing the bias voltage when the highest voltage among the voltages of the selected columns is smaller than a first comparison voltage and of increasing the bias voltage when the lowest voltage among the voltages of the selected columns is greater than a second comparison voltage.

According to an embodiment of the present invention, the column control circuits are made in the form of a current mirror comprising a reference branch and several duplication branches connected to the bias voltage, each duplication branch being connected to a column, the reference branch comprising a PMOS-type field-effect reference transistor having its source connected to the bias voltage, the gate and the drain of the reference transistor being interconnected, and a PMOS-type field-effect reference power transistor having its source connected to the drain of the reference transistor, the gate and the drain of the power transistor being connected to a reference current source providing a current equal to a predefined luminance current. Further, the first comparison signal is the voltage at the drain of the reference power transistor and the second comparison signal is the voltage at the drain of the reference transistor.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1, previously described, shows an electroluminescent matrix display;

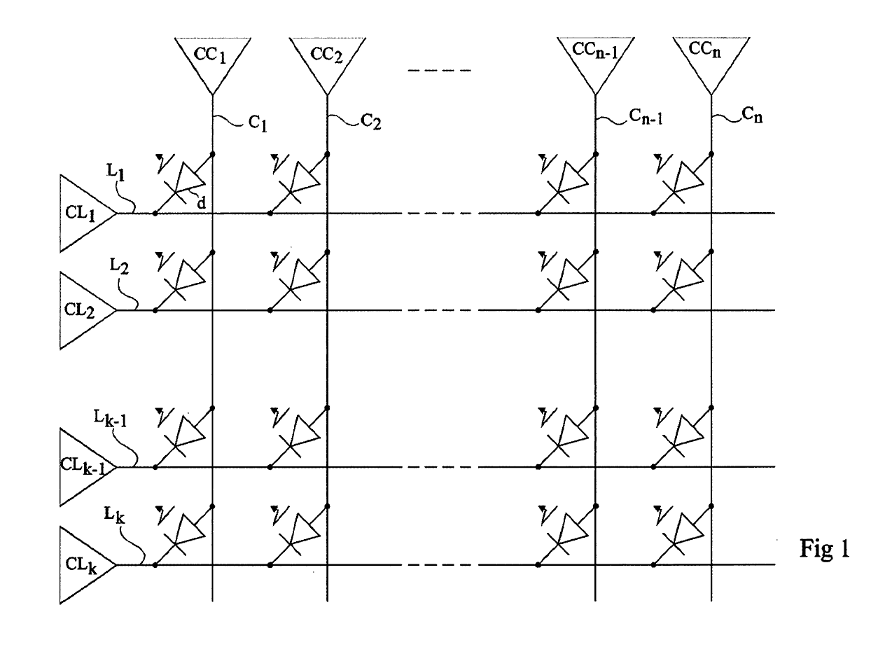

FIG. 2, previously described, shows a column control circuit and a line control circuit addressing a light-emitting diode of a screen;

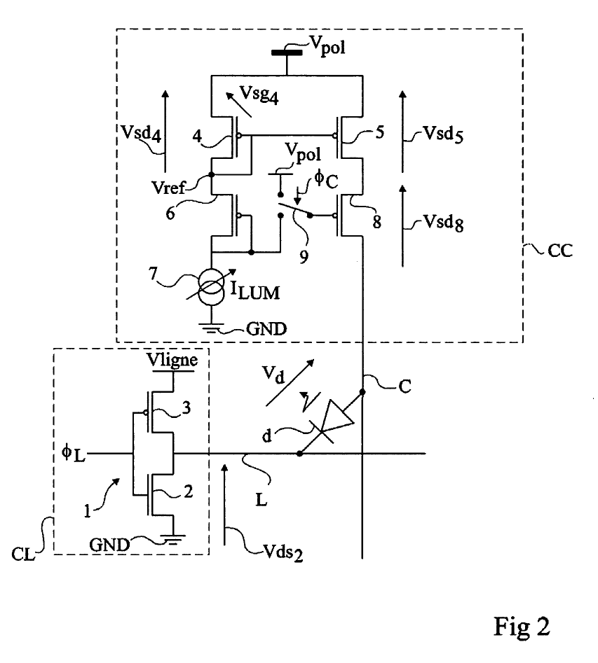

FIG. 3 illustrates an example of the forming of the regulation device according to the present invention; and

FIG. 4 illustrates a more detailed example of the forming of a portion of the device of FIG. 3.

### DETAILED DESCRIPTION

For clarity, the same elements have been designated with the same reference numerals in the different drawings.

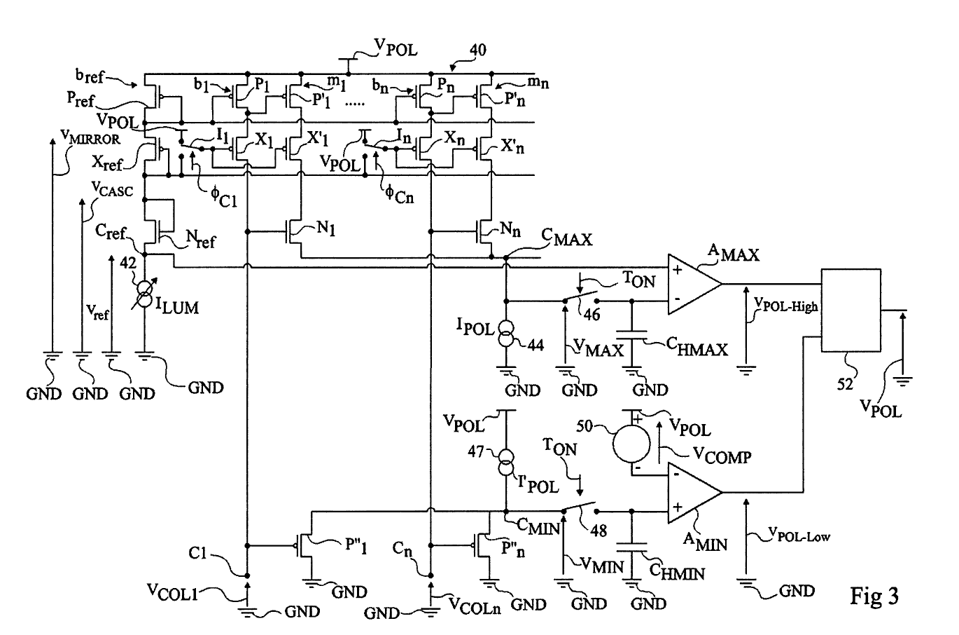

FIG. 3 shows an example of the forming of column control circuits and of the regulation device according to the present invention.

The column control circuits comprise a current mirror 40 formed in the present example of a reference branch b_{ref} and of n duplication branches b₁ to bₙ. Each branch is formed of a PMOS transistor, P_{ref} for the reference branch and P₁ to Pₙ for branches b₁ to bₙ. The sources of the transistors of each of the branches are connected to bias voltage V_{POL} and the gates are interconnected. The drain and the gate of transistor P_{ref} of reference branch b_{ref} are connected to a source of a PMOS power transistor X_{ref}. The gate and the drain of power transistor X_{ref} are interconnected. The drain of transistor X_{ref} is connected to the drain of an NMOS transistor N_{ref}. The gate and the drain of transistor N_{ref} are interconnected. The source of transistor N_{ref} is connected to a terminal of a reference current source 42 at a point C_{ref}. The other terminal of current source 42 is connected to ground GND. After, the voltage between point C_{ref} and ground GND is noted V_{ref}, the voltage between the drain of transistor X_{ref} and ground GND is noted V_{CASC}, and the voltage between the drain of transistor P_{ref} and ground GND is noted V_{MIRROR}.

Reference current source 42 provides a luminance current I_{LUM}. The drain of each transistor Pᵢ, i ranging between 1 and n, is connected to the source of a PMOS power transistor Xᵢ having its drain connected to a column Cᵢ. Each power transistor, X_{ref} and X₁ to Xₙ, enables maintaining the voltage between the source and the drain of the transistor, P_{ref} and P₁ to Pₙ, corresponding to the operating range of this transistor. The gate of each power transistor Xᵢ, i ranging between 1 and n, is connected to a terminal of a two-position switch Iᵢ, controlled by a signal φ_{Ci} and capable of connecting the gate of transistor Xᵢ to the drain of transistor X_{ref}, when signal φ_{Ci} is for example low, or to bias voltage V_{POL}, when signal φ_{Ci} is high. When signal φ_{Ci} is low, transistor Xᵢ is on and the voltage of column Cᵢ settles at operation voltage V_{COLi} of the column while current I_{LUM} flows through the column. The control circuits further comprise, for each column, a switch (not shown) capable of connecting column Cᵢ to ground GND.

The present invention comprises providing, for each duplication branch bᵢ, i ranging between 1 and n, a first measurement circuit mᵢ comprising a PMOS transistor P′ᵢ, having its source connected to bias voltage V_{POL} and having its gate connected to the drain of transistor Pᵢ of the corresponding duplication branch bᵢ. The drain of each transistor P′ᵢ is connected to the source of a PMOS power transistor X′ᵢ having its gate connected to the gate of power transistor Xᵢ of the corresponding duplication branch bᵢ. Power transistor X′ᵢ enables maintaining the voltage between the source and the drain of the associated transistor P′ᵢ within the operation range of this transistor. The drain of each power transistor X′ᵢ is connected to the drain of a follower-assembled NMOS transistor Nᵢ having its gate connected to point Cᵢ. The sources of transistors N₁ to Nₙ are connected, at a point C_{MAX}, to a terminal of a current source 44 having its other terminal connected to ground GND. The voltage between point C_{MAX} and ground GND is noted V_{MAX}. Current source 44 provides a bias current I_{POL} for the biasing of NMOS transistors N₁ to Nₙ. A switch 46, controlled by a signal T_{ON}, enables connecting point C_{MAX} to a terminal of a capacitor C_{HMAX} having its other terminal connected to ground GND. The voltage across capacitor C_{HMAX} drives the inverting input (−) of a comparator-assembled operational amplifier A_{MAX}. The non-inverting input (+) of amplifier A_{MAX} is connected to point C_{ref}. Amplifier A_{MAX} provides a binary control signal V_{POL}_{_{—}}_{High}.

For each column Cᵢ, with i varying from 1 to n, a second measurement circuit comprising a PMOS-type transistor P″ᵢ having its gate connected to column Cᵢ and having its drain connected to ground GND, is provided. The sources of transistors P″₁ to P″ₙ are connected, at a point C_{MIN}, to a terminal of a current source 47 providing a current I′_{POL} for the biasing of PMOS transistors P″₁ to P″ₙ. The voltage between point C_{MIN} and ground GND is noted V_{MIN}. A switch 48, controlled by signal T_{ON}, enables connecting point C_{MIN} to a terminal of a capacitor C_{HMIN} having its other terminal connected to ground GND. The voltage across capacitor C_{HMIN} drives the non-inverting input (+) of a comparator-assembled operational amplifier A_{MIN}. The inverting input (−) of amplifier A_{MIN} is connected to a terminal of a constant voltage generator 50, providing a constant voltage V_{COMP}, having its other terminal connected to bias voltage V_{POL}. Amplifier A_{MIN} provides a binary control signal V_{POL}_{_{—}}_{Low}.

Control signals V_{POL}_{_{—}}_{High}, V_{POL}_{_{—}}_{Low} are provided to an adjustment unit 52 which modifies the value of bias voltage V_{POL} according to the values of the control signals.

The present invention comprises regulating bias voltage V_{POL} so that, for each active column Cᵢ, the voltage of column V_{COLi} complies at best with the following relation:
V_{CASC}<V_{COLi}<V_{MIRROR}

Indeed, if voltage V_{COLi} is smaller than V_{CASC}, this means that, for the considered column Cᵢ, bias voltage V_{POL} is unnecessarily too high. Further, if voltage V_{COLi} exceeds V_{MIRROR}, then the current copying in column Cᵢ is incorrect since the source-drain voltage of transistor Pᵢ is smaller than the source-drain of transistor P_{ref}.

Practically, the highest voltage, noted V_{COLMAX}, among the voltages of active columns C₁ to Cₙ is selected to be compared with voltage V_{CASC} to determine whether bias voltage V_{POL} is too high.

More specifically, in an activation phase, the voltage of each column Cᵢ, with i varying from 1 to n, settles at a column voltage V_{COLi} that can vary from one column to another. Transistors N₁ to Nₙ being follower-assembled, voltage V_{MAX} follows the highest voltage V_{COLMAX} from among the voltages of C₁ to Cₙ. More specifically, voltage V_{MAX} is equal to the difference between voltage V_{COLMAX} and the gate-source voltage (imposed by I_{POL}) of transistor Nᵢ of column Cᵢ having the highest column voltage V_{COLi}. Switch 46 is on only when at least one pixel of a line is selected. In such a case, voltage V_{MAX} is applied across capacitor C_{HMAX}. The turn-on time of switch 46 can vary but does not exceed the duration of an activation phase of a screen line to avoid discharging of capacitor C_{HMAX} with current I_{POL}. Amplifier A_{MAX} compares voltage V_{MAX} with voltage V_{ref}. This amounts to comparing voltage V_{COLMAX} with voltage V_{CASC}, considering that the gate-source voltages of transistor N_{ref} and of transistors N₁ to Nₙ are equal. Amplifier A_{MAX} provides for example a control signal V_{POL}_{_{—}}_{High} at level “0” when voltage V_{MAX} is greater than voltage V_{ref} and a control signal V_{POL}_{_{—}}_{High} at level “1” when voltage V_{MAX} is smaller than voltage V_{ref}.

Among the active columns, some may exhibit a defect of “open” pixel type. An “open” pixel corresponds to a cutting in the connection between the column and the anode of the light-emitting diode of the pixel or to a cutting in the connection between the line and the cathode of the light-emitting diode of the pixel. An open column Cᵢ being at high impedance, voltage V_{COLi} of the column rises up to bias voltage V_{POL}. Voltage V_{COLMAX} would then be equal to V_{POL}, which would be incorrect.

The device according to the present invention enables not taking into account an open column for the determination of V_{COLMAX}. Indeed, in the case of an “open” pixel, for example, the pixel of column C₁, when power transistor X₁ is on, the column being open and at high impedance, the voltage at the drain of transistor P₁ rises up to bias voltage V_{POL}. The voltage on the gate of transistor P′₁ is then equal to bias voltage V_{POL} and transistor P′₁ is off. No current then flows through transistor P′₁. Transistor N₁ is then no longer supplied and can no longer charge capacitor C_{HMAX}.

However, with such a device, voltage V_{COLMAX} thus obtained cannot be used to determine whether bias voltage V_{POL} is too low. Indeed, if bias voltage V_{POL} became too low, voltage V_{COLi} of each active column Cᵢ would be equal to bias voltage V_{POL} so that the associated transistor P′ᵢ would be off. Capacitor C_{HMAX} would then be discharged by current I_{POL} and voltage V_{MAX} might decrease below voltage V_{CASC}, thus erroneously indicating that bias voltage V_{POL} would be too high.

To determine whether bias voltage V_{POL} is too low, the lowest voltage, noted V_{COLMIN}, from among the active columns voltages which is obtained separately from voltage V_{COLMAX}, is used. Voltage V_{COLMIN} is then compared with voltage V_{MIRROR} to determine whether bias voltage V_{POL} is too low.

More specifically, transistors P″₁ to P″ₙ being follower-assembled, voltage V_{MIN} follows the lowest voltage V_{COLMIN} from among the voltages of active columns C₁ to Cₙ. More specifically, voltage V_{MIN} is equal to the sum of voltage V_{COLMIN} and of the source-gate voltage of transistor P″ᵢ of column Cᵢ at voltage V_{COLMIN}. Theoretically, if it could be considered that the gate-source voltage of transistor P_{ref} is equal to the gate-source voltage of transistor P″ᵢ of column Cᵢ at voltage V_{COLMIN}, comparing voltage V_{COLMIN} with voltage V_{MIRROR} would be equivalent to comparing V_{MIN} with V_{POL}. In practice, to take transistor dispersions into account, V_{MIN} is compared with a voltage which is smaller than bias voltage V_{POL} by a constant voltage V_{COMP}, for example set to 300 mV. Amplifier A_{MIN} compares voltage V_{MIN} with voltage V_{POL}−V_{COMP} and provides a control signal V_{POL}_{_{—}}_{Low} at “1” when voltage V_{MIN} is greater than voltage V_{POL}−V_{COMP} and a control signal V_{POL}_{_{—}}_{Low} at “0” when voltage V_{MIN} is smaller than voltage V_{POL}−V_{COMP}.

By combining the information provided by control signals V_{POL}_{_{—}}_{High} and V_{POL}_{_{—}}_{Low}, all cases can be addressed:

first case: bias voltage V_{POL} is too low for the desired brightness level, which corresponds to V_{POL}_{_{—}}_{High}=0 and V_{POL}_{_{—}}_{Low}=1;

second case: bias voltage V_{POL} is too high for the desired brightness level, which corresponds to V_{POL}_{_{—High}}=1 and V_{POL}_{_{—}}_{Low}=0;

third case: bias voltage V_{POL} is correct for the desired brightness level, which corresponds to V_{POL}_{_{—}}_{High}=0 and V_{POL}_{_{—}}_{Low}=0.

The capacitances of capacitors C_{HMIN} and C_{HMAX} are sufficiently high to limit leakages at the level of these capacitors at least for the time corresponding to the activation of all the screen lines. This enables providing a correct bias voltage V_{POL} even in the case where a single screen line is lit in the display of an image on the screen.

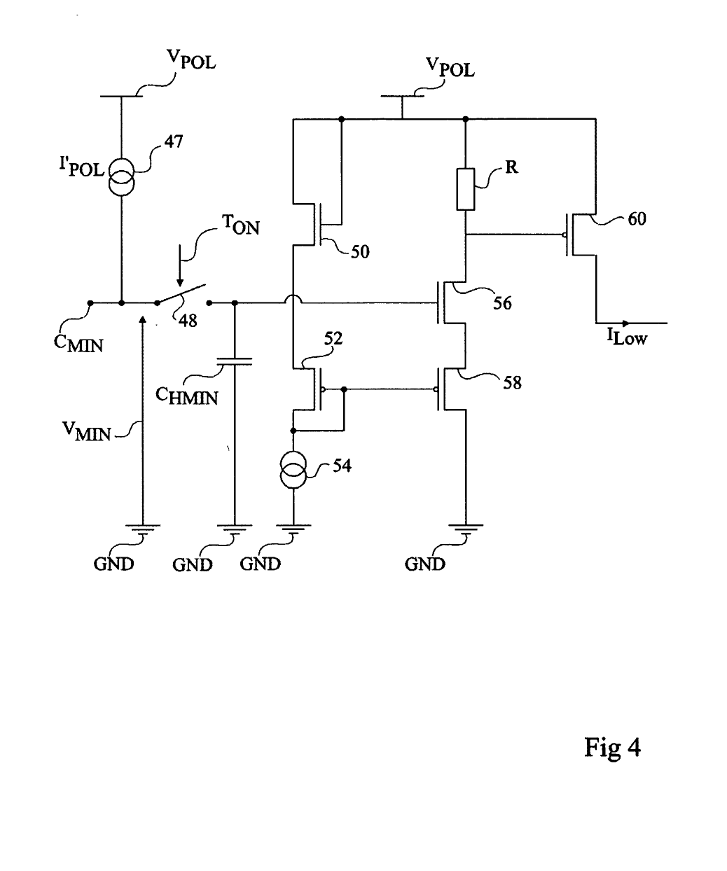

FIG. 4 shows an example of the forming of a circuit corresponding to comparator A_{MIN} and to constant voltage source V_{COMP}.

The circuit comprises an NMOS transistor 50 having its drain and gate connected to bias voltage V_{POL}. The source of transistor 50 is connected to the source of a PMOS transistor 52. The gate and the drain of transistor 52 are connected to a terminal of a constant current source 54 having its other terminal connected to ground GND. The circuit comprises an adjustable resistor R having a terminal connected to bias voltage V_{POL} and having its other terminal connected to the drain of an NMOS transistor 56. The gate of transistor 56 corresponds to the non-inverting input (+) of amplifier A_{MIN} of FIG. 3. The source of transistor 56 is connected to the source of a PMOS transistor 58. The gate of transistor 58 is connected to the gate of transistor 52 and the drain of transistor 58 is connected to ground GND. The drain of transistor 56 is connected to the gate of a PMOS transistor 60 having its source connected to bias voltage V_{POL}. Current I_{Low} at the drain of transistor 60 provides control signal V_{POL}_{_{—}}_{Low} after current-to-voltage conversion.

As an example, assume that column voltage V_{COL1} associated with column C₁ has the lowest operation voltage V_{COLMIN}. It is considered that the voltage of column C₁ must remain lower than V_{MIRROR}, that is, than the sum of voltage V_{CASC} and of the gate-source voltage of transistor X_{ref}, since beyond this value, the copying is poor. Voltage V_{MIRROR} is also equal to the difference between bias voltage V_{POL} and the gate-source voltage of transistor P_{ref}. When voltage V_{COL1} reaches this limit, voltage V_{MIN} applied across capacitor C_{HMIN} is equal to voltage V_{POL}−Vgs_{Pref}+Vgs_{P″1}, that is, equal to V_{POL} if the two gate-source voltages are considered as identical.

As long as voltage V_{MIN} is smaller than V_{POL}, transistor 58 is off and current I_{Low} is zero. When voltage V_{MIN} is greater than V_{POL}, a current flows through transistor 58 and thus through power transistor 60. Current I_{Low} coming out of the drain of transistor 60 can then be turned into a voltage to obtain control signal V_{POL}_{_{—}}_{Low}. In practice, the gate-source voltages of transistors P_{ref} and P″₁ are not perfectly identical and voltage V_{MIN} is rather compared with voltage V_{POL}−V_{COMP}, where voltage V_{COMP} is positive, to take into account dispersions on the different transistors. The dimensions of transistors 50 and 56 and the value of resistor R are then adjusted to adjust the comparator gain and the voltage for which it switches.

Of course, the present invention is likely to have various alterations, modifications, and improvements which will readily occur to those skilled in the art. In particular, the current mirrors may be formed with a greater number of transistors per branch.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A device for regulating the bias voltage of circuits for controlling columns of a matrix display formed of light-emitting diodes distributed in lines and in columns, the column control circuits being capable of selecting columns to turn on the light-emitting diodes of the selected columns and of a selected line of the matrix display, the device comprising:
a first measurement circuit providing a first measurement signal representative of the highest voltage among the voltages of the selected columns;
a second measurement circuit providing a second measurement signal representative of the lowest voltage among the voltages of the selected columns; and
an adjustment circuit receiving the first and second measurement signals and capable of decreasing the bias voltage if the first measurement signal is smaller than a first comparison signal and of increasing the bias voltage if the second measurement signal is greater than a second comparison signal.

2. The device of claim 1, wherein the adjustment circuit comprises:
a first storage circuit, capable of storing the first measurement signal for at least the duration of the display of an image on the matrix display in the absence of a new measurement of the first measurement signal; and
a second storage circuit, capable of storing the second measurement signal for at least the duration of the display of an image on the matrix display in the absence of a new measurement of the second measurement signal.

3. The device of claim 1, wherein the first measurement circuit is capable of measuring the maximum voltage from among the voltages of the matrix display columns, the measurement circuit comprising a protection circuit capable of deactivating the measurement circuit for each column associated with a non-conductive light-emitting diode.

4. The device of claim 2, wherein the column control circuits are made in the form of a current mirror comprising a reference branch and several duplication branches connected to the bias voltage, each duplication branch being connected to a column, the reference branch comprising a field-effect PMOS-type reference transistor having its source connected to the bias voltage, and having its drain connected to a reference current source providing a current equal to a luminance current, the gate and the drain of the reference transistor being interconnected, and wherein each duplication branch of the current mirror comprises a PMOS-type field-effect duplication transistor having its source connected to the bias voltage and having its drain connected to said column, the gates of the transistors of each branch being interconnected.

5. The device of claim 4, wherein the first measurement circuit comprises, for each column, a PMOS-type field-effect protection transistor having its source connected to the bias voltage and having its gate connected to the drain of the duplication transistor of the duplication branch associated with said column and an NMOS-type field effect measurement transistor, having its drain connected to the drain of the protection transistor and having its gate connected to the column, the sources of the first measurement transistors being connected to a measurement point.

6. The device of claim 5, wherein the reference branch further comprises a PMOS-type field-effect reference power transistor having its source connected to the drain of the reference transistor, the gate and the drain of the reference power transistor being connected to the reference current source, wherein each duplication branch further comprises a PMOS-type field-effect duplication power transistor having its source connected to the drain of the duplication transistor and having its drain connected to the column, and the gate of which is capable of being connected to the drain of the reference power transistor for selecting said column, the first comparison signal being the voltage at the drain of the reference power transistor.

7. The device of claim 4, wherein the second measurement circuit comprises, for each column, a PMOS-type field-effect measurement transistor having its drain connected to a reference voltage and having its gate connected to the column, the sources of the second measurement transistors being connected to a measurement point.

8. The device of claim 7, wherein the second comparison signal is equal to the bias voltage decreased by a determined constant voltage.

9. A matrix display comprising light-emitting diodes distributed in lines and columns and column control circuits capable of selecting columns to turn on the light-emitting diodes of the selected columns and of a selected line, said matrix display further comprising a device for regulating the bias voltage of the column control circuits of claim 1.

10. A method for regulating the bias voltage of circuits for controlling columns of a matrix display formed of light-emitting diodes distributed in lines and in columns, the column control circuits being capable of selecting columns to turn on the light-emitting diodes of the selected columns and of a selected line of the matrix display, said method comprising the steps of decreasing the bias voltage when the highest voltage among the voltages of the selected columns is smaller than a first comparison voltage and of increasing the bias voltage when the lowest voltage among the voltages of the selected columns is greater than a second comparison voltage.

11. The method of claim 10, wherein the column control circuits are made in the form of a current mirror comprising a reference branch and several duplication branches connected to the bias voltage, each duplication branch being connected to a column, the reference branch comprising a PMOS-type field-effect reference transistor having its source connected to the bias voltage, the gate and the drain of the reference transistor being interconnected, and a PMOS-type field-effect reference power transistor having its source connected to the drain of the reference transistor, the gate and the drain of the power transistor being connected to a reference current source providing a current equal to a predefined luminance current and wherein the first comparison signal is the voltage at the drain of the reference power transistor and the second comparison signal is the voltage at the drain of the reference transistor.
